(19) United States
(12) Patent Application Publication
(10) Pub. No.: US 2018/0063191 A1
(43) Pub. Date: Mar. 1, 2018

(54) SYSTEM AND METHOD FOR USING A VIRTUAL HONEYPOT IN AN INDUSTRIAL AUTOMATION SYSTEM AND CLOUD CONNECTOR

(71) Applicant: SIEMENS AKTIENGESELLSCHAFT, Munchen (DE)

(72) Inventor: Stefan Woronka, Baddeckenstedt (DE)

(73) Assignee: SIEMENS AKTIENGESELLSCHAFT, Munchen (DE)

(21) Appl. No.: 15/691,208

(22) Filed: Aug. 30, 2017

(30) Foreign Application Priority Data
Aug. 31, 2016 (EP) 16186580.3

(51) Int. Cl. H04L 29/06; G06F 9/455

(52) U.S. Cl. CPC H04L 63/1491; H04L 63/1408; G06F 2009/45595; G06F 2009/45587; G06F 9/45558

(57) ABSTRACT

A system includes a first network including a network device, a second network including a cloud-computing infrastructure, a module including a first interface and a second interface. The first interface is in communication with the first network and the second interface is in communication with the second network. The module includes a virtual honeypot which simulates the network device. Further disclosed are a Cloud Connector and a method of using the system.

### CROSS-REFERENCES TO RELATED APPLICATIONS

This application claims the priority of European Patent Application, Serial No. 16186580.3, filed Aug. 31, 2016, pursuant to 35 U.S.C. 119(a)-(d), the content of which is incorporated herein by reference in its entirety as if fully set forth herein.

### BACKGROUND OF THE INVENTION

The invention relates to a system and method for using a virtual honeypot in an industrial automation system and Cloud Connector.

An industrial automation system is used to control machines processes in manufacturing. Industrial automation system includes multiple computerized devices, which control industrial processes. The industrial devices generate a large amount of industrial automation system data to be monitored. The devices of an industrial automation system must work together in a coordinate way and performing operations. The local control algorithm may also perform local data analytics (on-board analytics).

Protecting an automation system network against unauthorized intrusion has proven more and more difficult over the years. Undesirable software such as malware may be used or created to disrupt device operation, gather sensitive information and/or gain access to automation systems. The undesirable software may comprise, for example, viruses, worms, Trojan horses, spy-ware, adware and/or other malicious programs. The recognition of these attacks, both from inside and outside of the automation system, is increasingly hampered by various technologies.

At present the detection is set on systems such as Security Information and Event Management, which collect data from all attached systems data. These are then submitted to a special engineering in each case. So relevant data can be collected. Traditional approaches to secure an automation system range from the deployment of intrusion detection systems to mechanism for blocking unauthorized network traffic, i.e. through the use of a network traffic filter such as a “firewall.”

A recent development has been the deployment of what are referred as “honeypots” in the state in the art.

A honeypot is a system designed to be susceptible to compromise by some potential unknown attacker.

Unfortunately, such a honeypot is very difficult to deploy, configure and administer in a manner that does not compromise the security of other machines in the network. Furthermore, such honeypots need to be installed locally.

It would therefore be desirable and advantageous to provide an improved system and improved method with a honeypot architecture that is easier to deploy, configure and administer, and to obviate other prior art shortcomings.

### SUMMARY OF THE INVENTION

According to one aspect of the present invention, a system includes a first network including a network device, a second network including a cloud-computing infrastructure, and a module including a first interface in communication with the first network, and a second interface in communication with the second network, said module including a virtual honeypot to simulate the network device.

According to another aspect of the present invention, a Cloud Connector includes a first interface in communication with a first network, said first network including a network device, a second interface in communication with a second network, said second network including a cloud-computing infrastructure, and a virtual honeypot configured to simulate the network device.

According to still another aspect of the present invention, a method includes establishing a first network with a network device, establishing a second network with a cloud-computing infrastructure, establishing a communication of the first network with a first interface of a module, establishing a communication of the second network with a second interface of the module, and simulating the network device with a preconfigured virtual honeypot in the module.

According to the present invention, it was recognized that industrial automation systems nowadays are more open for attacks from the cyber world than before. This is a result due to increased cross-linking or by an increased complexity through the use of various technologies. This complexity requires that unauthorized users are also increasingly active within the industrial automation system. This may consciously or unconsciously trigger attacks. The number of attacks from inside and outside is thus increasing. The recognition of these attacks is increasingly hampered by complex technology. Therefore, honeypots can be used. However, these are complicated to configure and to keep up to date. A further disadvantage is the local installation and maintenance.

This is now solved by the invention. Here a virtual honeypot which simulates/emulates exactly the at least one network device is provided. The central virtual installation and maintenance of a virtual honeypot invention enables a significant cost in comparison to a local installation. Similarly, the maintenance is much cheaper.

In addition, virtual honeypots, which are specifically adapted to the automation system, can be installed. Thus, a significantly higher level of protection is possible. As a result, the benefits of the honeypots are improved.

As a further result, a central and speedy detection of attacks on the industrial automation system connected to the cloud arises.

Further advantageous features are set forth in the dependent claims, and may be combined with one another in any desired manner in order to achieve further advantages.

According to another advantageous feature of the present invention, the module can be configured as a Cloud Connector. It should be noted, that the module is not limited to a Cloud Connector. The module can also be configured as an industrial controller, or another gateway. The module can be part of the second network or the first network but is not limited to these examples.

According to another advantageous feature of the present invention, the first network can be an industrial automation system. Advantageously, the second network may be a cloud. The network devices can then be field devices as described above.

In one example malicious traffic created by a sender, for example an attacker, is received by the virtual honeypot. A faked response to the malicious traffic is created then by the virtual honeypot. This response is forwarded to the sender for distraction.

According to another advantageous feature of the present invention, the virtual honeypot can monitor and/or record an activity of the sender which has created the malicious traffic. By monitoring the activity of an unauthorized intruder through the virtual honeypot, the network administrator can identify tactics and tools used by the attacker.

According to another advantageous feature of the present invention, the virtual honeypot can be executed as virtual machine or virtual appliance on the module. Advantageously, the virtual honeypot has no access to the protected second network. Therefore, there is no need to install the honeypot locally in the protected second network.

According to another advantageous feature of the present invention, the network device can include a parameter profile, with the virtual honeypot being downloaded from the second network with respect to this parameter profile. The profile of the network device can also be stored in the module. Via a corresponding interface to the second network the virtual honeypot can be updated easily.

According to another advantageous feature of the present invention, the virtual honeypot can include weak or no safety (or security) features. Thus the virtual honeypot becomes interesting for the attacker.

According to another advantageous feature of the present invention, the module can be configured as a software agent.

### BRIEF DESCRIPTION OF THE DRAWINGS

Other features and advantages of the present invention will be more readily apparent upon reading the following description of currently preferred exemplified embodiments of the invention with reference to the accompanying drawings, in which:

FIG. 1 shows a common architecture of an industrial automation system, and

FIG. 2 shows a first embodiment of an industrial automation system according to the present invention.

### DETAILED DESCRIPTION OF PREFERRED EMBODIMENTS

Throughout the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

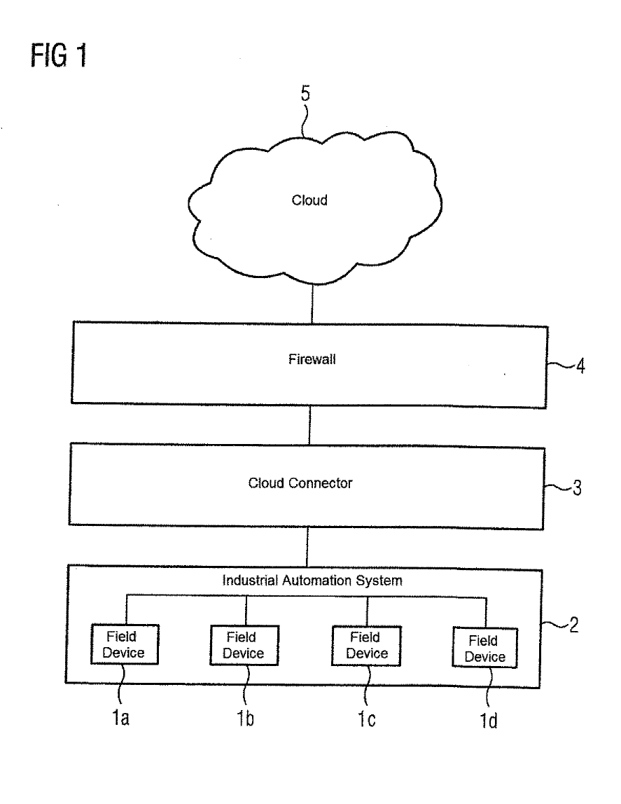

FIG. 1 shows a common industrial automation system 2 with field devices 1a-1d according to the state of the art. Field devices 1a-1d for recording and/or modifying process variables are frequently used in process automation system technology as well as in manufacture automation system technology. Measuring devices or sensors, such as level measuring devices, flow meters, pressure and temperature measuring devices, pH-redox potential meters, conductivity meters etc., are used for recording the respective process variables such as fill level, flow, pressure, temperature, pH level and conductivity. Actuators, such as e.g. valves or pumps, are used to influence process variables. Thus, the flow rate of a fluid in a pipeline section or a filling level in a container can be altered by means of actuators.

Field devices 1a-1d in general refer to all devices which are process-oriented and which provide or edit process-relevant information. In addition to the aforementioned measuring devices/sensors and actuators, units that are directly connected to a field bus and used for communication with superordinate units, such as e.g. remote I/Os, gateways, linking devices and wireless adapters, are also generally referred to as field devices. Because of the large number of system variables that must be monitored and controlled, industrial automation systems 2 often generate vast amounts of data. Moreover, such industrial automation systems 2 can operate on a twenty-four-hour basis. The industrial automation system data can be collected in a cloud 5. The industrial automation system data can be accumulated and made available to a user or users via the cloud 5. Where the field devices 1a-1d are distributed geographically, the cloud 5 advantageously provides a facility for accessing data from multiple, distributed field devices 1a-1d.

The term “cloud” is a shorthand reference to a network device with a cloud computing infrastructure. The cloud 5 includes one or more communication networks, such as the Internet, for example, and can further include portions of an industrial communications network, such as a local area network (LAN) or a wide area network (WAN). In cloud computing, a computing process may run on one or many connected cloud computers at the same time. In cloud computing, the cloud 5 can host and run an application anywhere in the world. Further, the cloud 5 enables access to the application from anywhere. The cloud 5 includes one or more data storage facilities for storing received industrial automation system data in some examples. The cloud 5 receives industrial automation system data from an industrial automation system 2 collected and passed by the Cloud Connector 3 and accumulates and stores the industrial automation system data. The cloud 5 in some examples processes and/or analyses the industrial automation system data.

If an industrial automation system 2 is attached to a cloud 5, then the field devices 1a-1d of the automation system 2, which can be attached, must be first determined, be recognized and categorized. The field devices 1a-1d collect data, which are then passed on to the cloud 5 through a Cloud Connector 3.

A Cloud Connector 3 plays everywhere a role where a link or an interface is required. The Cloud Connector 3 serves as a link between cloud-based application and existing on-premise systems, for example the industrial automation system 2. The Cloud Connector 3 can be executed as a software agent, e.g. as reverse invoke proxy. The Cloud Connector 3 runs as on-premise agent in a secured network and acts as a reverse invoke proxy between the on-premise network and the network devices with a cloud infrastructure (Cloud).

It is not uncommon for malicious users or pranksters to attempt to communicate with industrial automation system 2 for example with the field devices 1a-1d to steal delete or change data. Computer viruses, worms or Trojan horses may be distributed to the field devices 1a-1d. Security systems, such as firewalls 4 and antivirus software, provide significant protection of a typical industrial automation system 2.

Although such security systems provide defence against many types of attacks, even a careful examination of their event logs provides limited information regarding how an attack was mounted. Further, such technologies often miss many attacks and infections. This problem is now solved by the present invention.

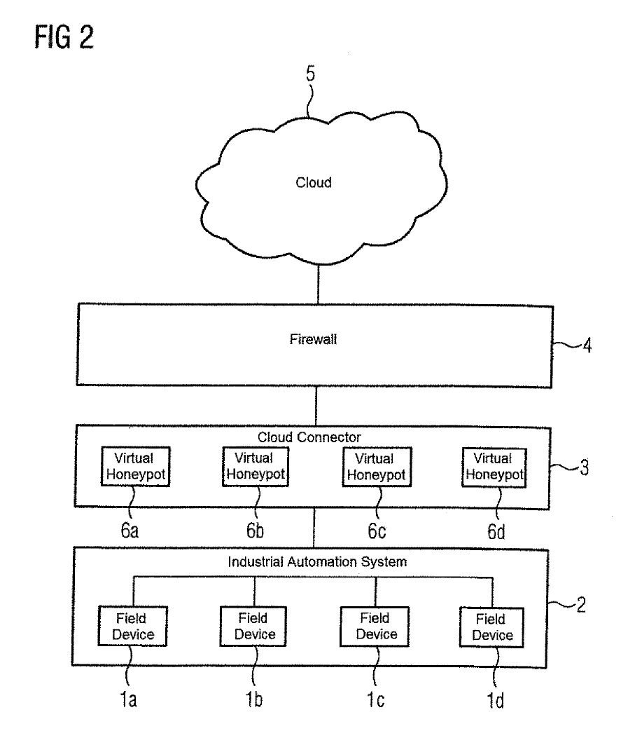

FIG. 2 shows a first embodiment of an industrial automation system according to the present invention.

The invention provides a virtual honeypot 6a-6d, which simulates the field device 1a-1d and is installed on the Cloud Connector 3. So in FIG. 1 a packet from an unknown client can be allocated to the virtual honeypot 6a-6d. Alternative (or in addition) a security application can be installed. The security application typically regulates or filters incoming network traffic in order to prevent unauthorized access, viruses, malware and other threads from reaching the protected network. So if the packet is allocated to the virtual honeypot 6a-6d or identified as a malware by the security application the packets is directed to the virtual honeypot 6a-6d. If the packet is not addressed to the virtual honeypot 6a-6d or the packets is not identified by the security application as a malware the packets can be processed normally. No legitimate traffic is directed to the virtual honeypot 6a-6d in the Cloud Connector 3. The attack can be from inside the industrial automation system 2 or from outside, e.g. a public network.

The virtual honeypot 6a-6d appears to be a local field device to the attacker.

The Cloud Connector 3 itself is aware of all the field devices 1a-1d, which are used in the industrial automation system 2. To build up the virtual honeypot 6a-6d the parameter profiles of the field devices 1a-1d is used. To get all the profiles and identify all the field devices 1a-1d a passive and an active scan can be done by the Cloud Connector 3. Of course this is just one possibility to gain all the parameter profile about the field devices 1a-1d. This profiles will now be used to download preconfigured honeypots 6a-6d from the cloud 5. These are then implemented as virtual machines or virtual appliance on the Cloud Connector 3. These virtual machine or virtual appliance then simulates the virtual honeypot 6a-6d. The virtual honeypot 6a-6d is then expected to attract the appropriate attacker.

Advantageously the Cloud Connector 3 creates a new virtual honeypot 6a-6d at the same time the Cloud Connector 3 becomes aware of a new field device 1a-1a. The virtual honeypot 6a-6d is deployed on the Cloud Connector 3 to simulate/emulate a local honeypot, here the field devices 1a-1d.

Therefore, advantageously all the field devices 1a-1d are simulated by a virtual honeypot 6a-6d in the Cloud Connector 3.

The peculiarity is, that the virtual honeypots 6a-6d exactly simulate the field devices 1a-1d, which are installed in the automation system 2. To make the virtual honeypots 6a-6d interesting for the attacker, they can be executed without any further safety measures. For example, a Web Server can be emulated without access protection in a virtual honeypot 6a-6d for PLCs (Programmable Logic Controller, PLC). An unpatched Windows version is also possible. If then the attacker attempts to contact a virtual honeypot 6a-6d, this will be recognized by the virtual honeypot 6a-6d. The activities of the attacker can be tracked down, collected and reported for example as an activity report to the cloud 5, for example to the company which runs the cloud 5. Therefore, an appropriate interface to the cloud 5 must be present. This activity report can be used for creating new honeypots 6a-6d and updating the virtual honeypots 6a-6d can be done easily through the cloud 5.

The virtual honeypots 6a-6d advantageously need not even be connected with any of the components of the rest of the second network, here the industrial automation system 2. In fact, the virtual honeypot 6a-6d and industrial automation system 2 can be operated and maintained by specialists completely separate from the organization administering the industrial automation system 2. The virtual honeypot 6a-6d can be operated as a service to the organization running the industrial automation system 2.

The virtual honeypot 6a-6d therefore appears to other systems to be a local field device 1aa-1d. The virtual honeypot 6a-6d further monitors and tracks attacker's activity, and provides activity data such as activity reports to the cloud's administrator by a special interface, so that the administrator can use the data to learn how attackers attempt to gain access to devices and can gather forensic evidence to aid in the identification and prosecution of attackers. Further, the virtual honeypot 6a-6d may divert attacks from real field devices 1a-1d, effectively diverting dangerous activity away from sensitive networked assets.

The virtual honeypot 6a-6d includes mail servers, database servers, or other systems that provide faked information or services that may be attractive to an attacker.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A system, comprising:
a first network including a network device;
a second network including a cloud-computing infrastructure; and
a module including a first interface in communication with the first network, and a second interface in communication with the second network, said module including a virtual honeypot to simulate the network device.

2. The system of claim 1, wherein the module is configured as a Cloud Connector.

3. The system of claim 1, wherein the first network is an industrial automation system.

4. The system of claim 1, wherein the virtual honeypot receives a malicious traffic created by a sender, creates a response to the malicious traffic, and forwards the response to the sender.

5. The system of claim 4, wherein the virtual honeypot monitors and/or records an activity of the sender which has created the malicious traffic received by the virtual honeypot.

6. The system of claim 1, wherein the virtual honeypot is executed as a virtual machine or a virtual appliance on the module.

7. The system of claim 1, wherein the network device has a parameter profile, said virtual honeypot being downloaded from the second network with respect to the parameter profile.

8. The system of claim 7, wherein the parameter profile of the network device is stored in the module.

9. The system of claim 1, wherein the module is configured as a software agent.

10. The system of claim 1, wherein the module is part of the first network.

11. A Cloud Connector, comprising:
a first interface in communication with a first network, said first network including a network device;
a second interface in communication with a second network, said second network including a cloud-computing infrastructure; and
a virtual honeypot configured to simulate the network device.

12. The Cloud Connector of claim 11, wherein the virtual honeypot receives a malicious traffic created by a sender, creates a response to the malicious traffic, and forwards the response to the sender.

13. The Cloud Connector of claim 12, wherein the virtual honeypot monitors and/or records an activity of the sender which has created the malicious traffic received by the virtual honeypot.

14. The Cloud Connector of claim 11, wherein the virtual honeypot is executed as a virtual machine or a virtual appliance on the module.

15. The Cloud Connector of claim 11, wherein the network device has a parameter profile, said virtual honeypot being downloaded from the second network with respect to the parameter profile.

16. The Cloud Connector of claim 15, wherein the parameter profile of the network device is stored in the Cloud Connector.

17. A method, comprising:
establishing a communication of a first network with a first interface of a module, wherein the first network comprises a network device;
establishing a communication of a second network with a second interface of the module, wherein the second network comprises a Cloud Computing infrastructure; and
simulating the network device with a preconfigured virtual honeypot in the module.

18. The method of claim 17, further comprising downloading the preconfigured virtual honeypot from the second network based on a parameter profile of the network device.

19. The method of claim 17, wherein simulating the network device with the preconfigured virtual honeypot comprises:
detecting a malicious traffic created by a sender;
creating a response to the malicious traffic; and
forwarding the response to the sender.

20. The method of claim 19, further comprising monitoring an activity of the sender which has created the malicious traffic received by the virtual honeypot.
